(19) United States
(12) Patent Application Publication
(10) Pub. No.: US 2003/0051382 A1
(43) Pub. Date: Mar. 20, 2003

(54) Adhesive-label and backing arrangement

(75) Inventor: Mauro Sinato, Volpiano-Torino (IT)

Correspondence Address: OBLON, SPIVAK, MCCLELLAND, MAIER & NEUSTADT, P.C., 1940 DUKE STREET, ALEXANDRIA, VA, 22314, US

(73) Assignee: L'OREAL, Paris (FR)

(21) Appl. No.: 10/246,677

(22) Filed: Sep. 19, 2002

(30) Foreign Application Priority Data
Sep. 19, 2001 (FR) 0112094

(51) Int. Cl. G09F 3/10; B32B 33/00

(52) U.S. Cl. 40/638; 428/41.8; 428/41.7

(57) ABSTRACT

An adhesive-label and backing arrangement in which a tape which can be wound onto a core, has removably adhesively-bonded labels on at least one face or surface. The tape further includes an arrangement for reducing stresses exerted on the labels in a direction longitudinal to the tape when winding the tape around the core and/or when unwinding it. The arrangement can include one or more strips disposed on the tape. By reducing stresses that can be exerted onto the labels, defects, such as undesired movement of the labels on the strip, can be avoided.

### CROSS REFERENCE TO RELATED APPLICATIONS

This document claims priority to French application number 0112094 filed Sep. 19, 2001, the entire content of which is hereby incorporated by reference.

### FIELD OF THE INVENTION

The present invention relates to an adhesive-label and backing arrangement in the form of a tape, in which the tape has labels disposed thereon and can be wound upon a core for subsequent use.

### BACKGROUND OF THE INVENTION

### DISCUSSION OF BACKGROUND

Before being adhesively bonded to the products for which they are intended, adhesive labels are often provided in the form of a roll. For example, FR 1 342 161 describes a ribbon formed from a paper tape, with one face or surface is coated with an adhesive and intended to be cut in order to form labels. The ribbon forming the labels can be directly wound without being adhesively bonded to a backing.

To protect the face coated with an adhesive, the adhesive labels are preferably adhesively bonded to a backing layer which can be in the form of a tape, and the tape is wound onto a core. The labels then completely or partially cover the backing tape. This method of packaging is often used for small labels.

Tapes having labels which only partially cover the backing can include a backing layer having one face which is, for example, a siliconized surface. This face is completely covered with an adhesive paper so that the adhesive paper is removably adhesive-bonded to the siliconized face. This tape then passes along a cutting line where the layer of adhesive paper is cut in order to form a plurality of labels regularly spaced over the backing layer (which is not cut). That part of the adhesive paper which does not form the labels is then removed from the backing so as to leave only the labels on the backing. At the end of the line, the tape provided with labels thus obtained is wound around a core, with the face of the tape having the labels preferably facing toward the core.

However, problems arise when winding such tapes onto a core because the associated winding tension needed to obtain a correctly wound roll is relatively high. This tension can cause the labels to slide on the backing, particularly when the labels are small. As can be seen in FIG. 1, the outer face 10b of the preceding turn exerts a relatively high friction F on the labels 20 of the portion of tape 10 which has just been wound around this turn, such that the small area of adhesive which holds the labels on the backing is insufficient to keep the labels in position on the backing. As a result, the labels can move such that they are irregularly positioned on the backing, and some labels are even removed from the backing. Such a tape is then difficult to use with equipment that automatically applies the labels by regularly taking a label from the backing and then adhesively bonding the label to a product.

Backing tapes to which adhesive labels are adhesively bonded as described in U.S. Pat. Nos. 4,307,526 and 6,183,016 can be particularly susceptible to the above problems.

One solution for solving such a problem involves decreasing the tension associated with winding the tape on its core at the end of the cutting line. However, when the winding tension is reduced, the roll is unstable and the tape moves with a “concertina” effect. Consequently, the tape is not correctly tensioned upstream of the winding station, such that the cutting operation cannot be carried out correctly. In particular, the gap between two labels is not regular throughout the length of the tape. Furthermore, each label is not very accurately cut.

### SUMMARY OF THE INVENTION

It is one of the objects of the invention to produce an adhesive-label and backing arrangement in the form of a tape, which does not have the drawbacks discussed above.

Another object of the invention is to produce a label and backing arrangement in which the labels are regularly arranged.

It is yet another object of the invention to produce a label and backing arrangement in which the labels are accurately cut.

Another object of the invention is to provide a label and backing arrangement which is simple to produce, without increasing its manufacturing cost.

According to the invention, these objects are achieved by producing an adhesive-label backing that includes a tape intended to be wound onto a core, with at least one face of the tape having removable adhesive-bonded labels, and with the tape configured or made so as to reduce the stresses exerted on the labels in a direction longitudinal to the tape when winding the tape around the core and/or when unwinding it.

With the arrangement of the invention, the tape to which the labels are adhesively bonded can be wound with a sufficiently high winding tension to obtain a correctly wound roll while avoiding or reducing the possibility of the labels sliding over their backing, particularly when they only partially cover one or both faces of the tape. The problems previously discussed are avoided or at least reduced because the friction exerted on a label in the longitudinal direction of the tape (by the face of the turn upon which it has just been wound or by the turn which has just been wound upon it) is reduced. Similarly, when unwinding the roll (for example, to feed a machine for applying labels), the friction exerted on a label in a longitudinal direction of the tape, by the face of the turn from which it is unwound, is reduced.

According to a preferred embodiment, the arrangement for reducing the longitudinal stresses includes at least one adhesive strip adhesively bonded to the tape and extending continuously or discontinuously over the tape. Preferably, the at least one strip extends along the longitudinal direction of the tape. When the at least one strip extends discontinuously, each portion of strip is preferably placed facing a label that is substantially in the same position as the label along the length of the tape. Also, preferably each portion of strip has a length substantially equal to the length of the label along the axis of the tape. It is also possible to provide a portion of the strip facing each label, only facing one label out of two, or facing one label out of three or more. Alternatively, or in addition, the strips can be disposed to extend over the width of the tape.

The at least one strip may be adhesively bonded to a single face or to both faces of the tape, especially when each face has labels. When the tape has labels on a single face, the at least one strip is preferably adhesively bonded to the face having the labels thereon. Alternatively, however, the at least one strip can be adhesively bonded to the face which does not have labels. In all cases, the presence of at least one strip makes it possible to increase the thickness of that portion of tape which does not have a label or the portion formed only by the backing, to thereby reduce the longitudinal stresses exerted on the labels by distributing the stresses over the at least one strip.

Preferably, the labels and the at least one strip have substantially the same thickness. Thus, the friction exerted on the label in a direction longitudinal to the tape is reduced, preferably as much as possible, however without increasing the thickness of the roll obtained and therefore maintaining, for the same roll diameter, the same number of labels. Furthermore, the presence of strips which are no thicker than the labels does not cause problems in removing the latter before being adhesively bonded to the final product in an automatic line.

Advantageously, the arrangement for limiting the stresses can include two strips extending continuously or discontinuously over the tape, on each side of the labels. This arrangement allows stresses to be distributed in a balanced manner on either side of the labels. Furthermore, the tape can be wound regularly, that is to say without having an excessive or asymmetrical thickness on one side, which makes it possible to obtain a more nearly perfect cylindrical roll which is therefore stable. Where discontinuous strips are used, a portion of strip can be placed to face one label out of two on one side of the tape, with the presence or the absence of a strip portion being reversed on the other side of the tape so that only a single portion of strip is placed facing a given label. In other words, a portion of strip is placed facing a first label to the right of the first label, another portion of strip is placed facing the following label to the left of this label, and so on, with the strip portions disposed in an alternating or staggered fashion.

With the invention the strips can be advantageously placed on each of the longitudinal edges of the tape. Thus, when the strips are continuous, the roll obtained has full edges. In other words, there is no space between the edges of two consecutive turns. The roll is therefore more compact and the turns do not have a tendency to slide over each other, which stabilizes the roll. Moreover, the tape fitted with labels can be cut into sheets to be fed to the label application machine in a flat manner from a stack of these sheets. This can be particularly suitable where the tape is relatively wide and when it includes relatively large labels, or else several small labels on the same width of tape. In such cases, the presence of strips on the edges makes it possible to further stabilize the stack of sheets to be fed to the application machine/equipment.

The labels and the strips can be formed by cutting a layer of adhesive material substantially covering the entire tape. Such a backing is simple to produce, and can be made without additional equipment costs since it can use the same cutting station as that used to cut the labels, with only the shape of the cut being altered.

In addition, when using strips placed on each of the longitudinal edges of the tape, it is possible to produce sufficiently wide strips to distribute the stresses over a fairly large area and the strips are sufficiently far from the labels so as not to damage the labels when the adhesive material located between the labels and the strips is removed. Furthermore, the cutting operation is simplified since only a single edge of the strip need be cut.

In accordance with one form of the invention, the labels are, for example, in the shape of a disc, preferably a disc having a small diameter, for example, a disc with a diameter less than a centimetre. Such labels can be used, for example, to be adhesive-bonded to tubes of mascara or to bottles of nail polish.

The strips will preferably have substantially the same thickness as the labels. Where printing is provided on the labels, the printing need not be provided on the strips such that the stip or strips differ from the labels by only the thickness of the printing, e.g., on the order of a few micrometers, and the thicknesses nevertheless are substantially the same. Alternately, printing can be provided on the strip or strips so that strip thickness even more closely matches that of the labels. The provision of printing on the strip or strips can be particularly desirable where a thick printing, such as a printing with an expandable ink is utilized, so that the strip thickness more closely matches the label thickness.

### BRIEF DESCRIPTION OF THE DRAWINGS

The above and additional objects and advantages of the invention will become readily understood in view of the detailed description herein, particularly when considered in conjunction with the drawings in which:

FIG. 1 is a perspective a view in section of a label backing of the prior art in the winding phase;

FIG. 2 is a perspective view of a label backing according to the invention in the winding phase;

FIG. 3 is a cross-sectional view of one embodiment of a wound portion of the label backing according to the invention;

FIG. 4 is a top view of a portion of tape for another embodiment of the invention.

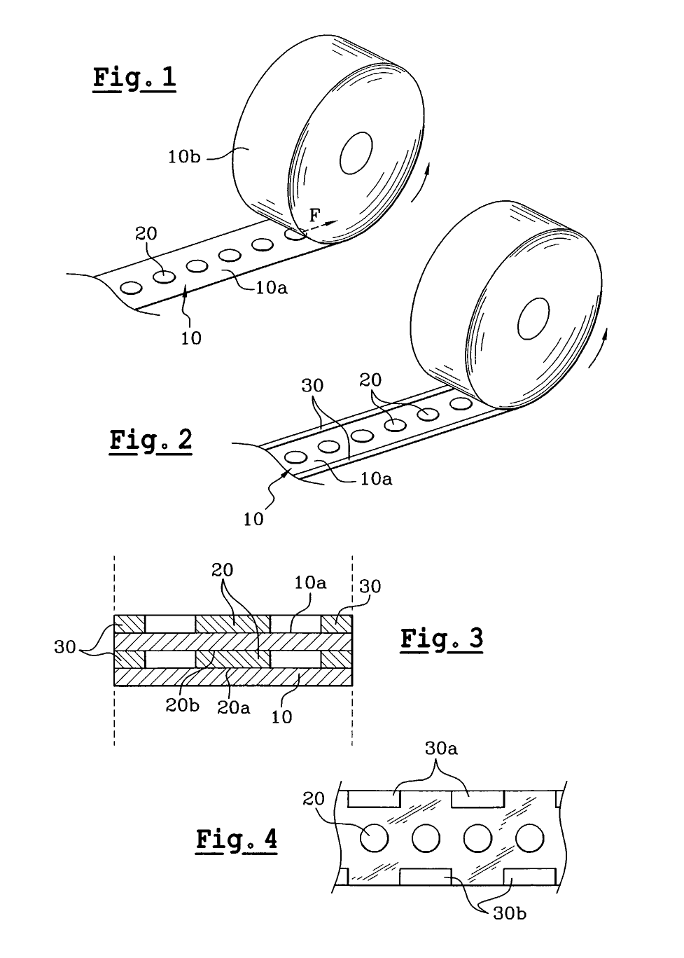

### DETAILED DESCRIPTION OF THE PREFERRED EMBODIMENTS

The label backing shown in FIG. 2 includes a tape 10 made of paper, one face 10a of which has a surface upon which labels are removably mounted, for example, with the face 10a siliconized. This tape has, for example, a width of about 19 mm and a thickness of about 0.6 mm.

As can be seen in FIGS. 2 and 3, the siliconized face 10a of the tape 10 includes a plurality of round labels 20 centred on the width of the tape and spaced regularly over the length of the tape by about 5 mm, for example. The labels have, for example, a diameter approximately equal to 7 mm and a thickness of about 0.02 mm. The labels are removably adhesive-bonded to the siliconized face so that they can be removed from the backing in order to be adhesively bonded to the product for which they are intended. The labels can be made, for example, of paper, with one face 20a covered with adhesive, for example, an acrylic adhesive. It is also possible to use an adhesive of the “hot melt” type or any other type of adhesive, which is chosen according to the product to which the labels will be bonded. The second face 20b of the label is covered with a pattern (not shown) obtained by printing the pattern relating to the final product to which the label will be affixed.

As shown in the illustrated embodiment, a strip 30 is placed on each longitudinal edge of the tape 10, on either side of the labels. These strips have, for example, a width of about 3 mm. The space provided between a label and a strip is at least equal to 1 mm such that the portion of adhesive paper present in this space may easily be removed without damaging the labels. According to the example described, the space is 3 mm. The strips 30 are advantageously made from the same material as the labels, for example, they can be made from an adhesive paper. However, the strips need not be covered with a pattern or printing since they are not intended to be adhesively bonded to a product (as is the case for the labels) but they are only intended to remain on the backing. The strips therefore have substantially the same thickness as the labels, the only difference corresponding to the thickness of printing ink covering the labels, which is on the order of a few micrometers. Alternately, printing can be provided on the strip or strips so that strip thickness more closely matches that of the labels. The provision of printing on the strip or strips can be particularly desirable where a thick printing, such as a printing with an expandable ink, so that the strip thickness more closely matches the label thickness.

To obtain such a backing, initially, a backing in the form of a tape is used, which is completely covered with the layer intended to form the labels. Next, the pattern desired for each label is printed, then the tape is passed through a cutting station of the flat or rotary type, where the labels and each strip are cut. The portion of adhesive paper located between the labels and the strips is then removed. The strip thus obtained is wound around a core with a winding tension conventionally chosen according to the tape, especially its length, its thickness and the type of material used, and the winding speed. The longitudinal stresses F exerted on the labels present on the last turn are low enough so that the labels are not caused to slide on the backing.

According to another embodiment of the invention shown in FIG. 4, discontinuous strips are provided on each longitudinal edge of the tape. Each label has a portion of strip 30a or 30b placed at its height on one side, the side alternating from left to right for two consecutive labels. Preferably, the discontinuous strip formed by the portions 30a located on one side of the labels is the complement of the strip formed by the portions 30b located on the other side of the labels. Thus, the backing tape is covered with a portion of strip 30a or 30b throughout the length of the tape, from one side to the other.

In the embodiments described above, the tape is preferably wound around the core such that the face to which the labels are adhesively bonded is oriented towards the core. The labels of the last turn are thus protected by the face of the tape which has no label. No additional protection is then needed. However, as an alternative, provision can be made for the tape to be wound inversely, that is to say, the face to which the labels are adhesively bonded faces outwardly from the roll. With this arrangement, preferably the last turn is covered to protect the last turn, for example, with a protective film.

According to a variant (not shown), the backing tape can have two siliconized faces, with each having labels thereon. With this arrangement, each side or face of the backing tape can have two continuous or discontinuous longitudinal strips provided thereon, with one continuous strip on either side of the labels or a plurality of discontinuous strips on either side of the labels as discussed earlier. Here again, a protective film can be provided to protect the labels of the last turn.

In the detailed description above, reference was made to preferred embodiments of the invention. However, variants may be made thereto without departing from the spirit of the invention as claimed below. The present invention may especially be applied to backings of a tape of any width on which labels of any size and any shape are adhesively bonded, whether or not they are regularly spaced over the length of the tape. In addition, several labels can be placed on the same width of tape, throughout the length of the tape.

Obviously, numerous modifications and variations of the present invention are possible in light of the above teachings. It is therefore to be understood that, within the scope of the appended claims, the invention may be practiced otherwise than as specifically described herein.

What is claimed is:

1. An adhesive label and backing arrangement comprising:
a tape which can be wound onto a core, said tape including first and second faces on opposite sides thereof, and wherein at least said first face includes removably adhesive-bonded labels thereon; and
means provided on the tape for reducing stresses, exerted on the labels in a longitudinal direction of the tape, which can occur during a winding of the tape onto a core or an unwinding of the tape from a core.

2. An adhesive label and backing arrangement as recited in claim 1, wherein said means comprise at least one strip adhesively bonded to the tape

3. An adhesive label and backing arrangement as recited in claim 2, wherein said at least one strip includes at least one strip extending continuously along a length of said strip upon which a plurality of said adhesive bonded labels are disposed.

4. An adhesive label and backing arrangement as recited in claim 2, wherein said at least one strip includes a plurality of strips disposed along a length of said strip upon which a plurality of said adhesive bonded labels are disposed.

5. An adhesive label and backing arrangement as recited in claim 4, wherein said plurality of strips are spaced from one another.

6. An adhesive label and backing arrangement as recited in claim 2, wherein the at least one strip is disposed on the first face of said tape.

7. An adhesive label and backing arrangement as recited in claim 6, wherein the adhesive-bonded labels and the at least one strip have substantially the same thickness.

8. An adhesive label and backing arrangement as recited in claim 2, wherein the adhesive-bonded labels and the at least one strip have substantially the same thickness.

9. An adhesive label and backing arrangement as recited in claim 2, which the adhesive-bonded labels and the at least one strip are formed by cutting a layer of adhesive bonded material covering substantially the entire tape and removing portions of said adhesive bonded material from said tape.

10. An adhesive label and backing arrangement as recited in claim 1, wherein the means provided on the tape for reducing stresses includes at least a first strip and a second strip, and wherein with respect to a width direction of said tape said adhesive-bonded labels are disposed between said first strip and said second strip.

11. An adhesive label and backing arrangement as recited in claim 10, wherein said first strip and said second strip each extend continuously along a length of said strip upon which a plurality of said adhesive-bonded labels are disposed.

12. An adhesive label and backing arrangement as recited in claim 1, wherein said at least one strip includes a first plurality of strips and a second plurality of strips, and wherein with respect to a width direction of said tape, said adhesive-bonded labels are disposed between said first plurality of strips and said second plurality of strips.

13. An adhesive label and backing arrangement as recited in claim 12, wherein adjacent strips of said first plurality of strips are spaced from each other in the longitudinal direction of said tape, and wherein adjacent strips of said second plurality of strips are spaced from each other in the longitudinal direction of the tape.

14. An adhesive label and backing arrangement as recited in claim 13, wherein said first and second plurality of strips are positioned such that at a position with respect to the longitudinal direction of said tape at which a space between adjacent strips of said first plurality of strips is located one of said second plurality of strips is present, and further wherein at a position with respect to the longitudinal direction of said tape at which a space between adjacent strips of said second plurality of strips is located one of said first plurality of strips is present.

15. An adhesive label and backing arrangement as recited in claim 2, wherein said at least one strip includes a first strip extending along a first longitudinal edge of said tape and a second strip extending along a second longitudinal edge of said tape.

16. An adhesive label and backing arrangement as recited in claim 15, wherein said adhesive-labels are positioned between said first and second longitudinal edges.

17. An adhesive label and backing arrangement as recited in claim 2, wherein said at least one strip includes a first plurality of strips extending along a first longitudinal edge of said tape and a second plurality of strips extending along a second longitudinal edge of said strip.

18. An adhesive label and backing arrangement as recited in claim 17, wherein a first plurality of spaces are present between strips of said first plurality of strips and a second plurality of spaces are present between strips of said second plurality of strips, and further wherein spaces of said first plurality of spaces are offset from spaces of said second plurality of spaces with respect to the longitudinal direction of said tape.

19. An adhesive label and backing arrangement as recited in claim 1, wherein the adhesive-bonded labels are disc-shaped.

20. An adhesive backing and label arrangement as recited in claim 2, wherein said at least one strip is formed of a material which is the same as that of said adhesive-labels.

21. A label and backing arrangement comprising:
a tape including first and second faces, said tape including a longitudinal direction extending along a length of said tape and a widthwise direction extending along width of said tape;
a plurality of labels provided on at least one of said first and second faces of said tape; and
at least one strip disposed on said tape and extending along the longitudinal direction of said tape.

22. A label and backing arrangement as recited in claim 21, wherein said at least one strip is spaced from said plurality of labels in the widthwise direction of said tape.

23. A label and backing arrangement as recited in claim 22, wherein said plurality of labels are spaced from each other along the longitudinal direction of said tape.

24. A label and backing arrangement as recited in claim 23, wherein said labels have a thickness which is substantially the same as a thickness of said at least one strip.

25. A label and backing arrangement as recited in claim 24, wherein said at least one strip includes a first strip and a second strip, and wherein said plurality of labels are positioned with respect to said widthwise direction between said first strip and said second strip.

26. A label and backing arrangement as recited in claim 25, wherein said first strip extends along a first longitudinal edge of said tape and said second strip extends along a second longitudinal edge of said tape.

27. A label and backing arrangement as recited in claim 26, wherein said plurality of labels are disc-shaped.

28. A label and backing arrangement as recited in claim 24, wherein said at least one strip includes a first plurality of strips and a second plurality of strips, and wherein said plurality of labels are positioned with respect to said widthwise direction between said first plurality of strips and said second plurality of strips.

29. A label and backing arrangement as recited in claim 28, wherein a first plurality of spaces are provided between strips of said first plurality of strips and a second plurality of spaces are provided between strips of said second plurality of strips.

30. A label and backing arrangement as recited in claim 29, wherein spaces of said first plurality of spaces are offset from spaces of said second plurality of spaces with respect to said longitudinal direction.

31. A label and backing arrangement as recited in claim 30, wherein said first plurality of strips extends along a first longitudinal edge of said tape and said second plurality of strips extends along a second longitudinal edge of said tape.

32. A label and backing arrangement as recited in claim 28, wherein said first plurality of strips extends along a first longitudinal edge of said tape and said second plurality of strips extends along a second longitudinal edge of said tape.

33. A label and backing arrangement as recited in claim 28, wherein said plurality of labels are disc-shaped.

34. A label and backing arrangement as recited in claim 21, wherein said at least one strip includes a strip extending along a length of at least a plurality of said labels in the longitudinal direction of said tape.

35. A label and backing arrangement as recited in claim 34, wherein said strip extends along a first longitudinal edge of said tape.

36. A label and backing arrangement as recited in claim 21, wherein said at least one strip includes a first strip and a second strip, wherein each of said first and second strips extends along a length of at least a plurality of said labels in the longitudinal direction of said tape.

37. A label and backing arrangement as recited in claim 36, wherein said first strip extends along a first longitudinal edge of said tape and said second strip extends along a second longitudinal edge of said tape.

38. A label and backing arrangement as recited in claim 21, wherein said at least one strip includes a plurality of strips spaced from one another in the longitudinal direction of said tape.

39. A label and backing arrangement as recited in claim 21, wherein said at least one strip includes a first plurality of strips and a second plurality of strips, and wherein said plurality of labels are disposed between said first plurality of strips and said second plurality of strips with respect to said widthwise direction.

40. A label and backing arrangement as recited in claim 39, wherein a first plurality of spaces are provided between strips of said first plurality of strips and a second plurality of spaces are provided between strips of said second plurality of strips.

41. A label and backing arrangement as recited in claim 40, wherein spaces of said first plurality of spaces are offset from spaces of said second plurality of spaces with respect to said longitudinal direction.

42. A label and backing arrangement as recited in claim 41, wherein said first plurality of strips extends along a first longitudinal edge of said tape and said second plurality of strips extends along a second longitudinal edge of said tape.

43. A label and backing arrangement as recited in claim 21, wherein said at least one strip is formed of a material which is the same as that of said plurality of labels.
